(19) United States
(12) Patent Application Publication
(10) Pub. No.: US 2015/0265383 A1
(43) Pub. Date: Sep. 24, 2015

(54) DENTAL FLOSSING DEVICE

(71) Applicant: Flexi Floss Ltd., Haifa (IL)

(72) Inventors: Erella Pines, Pardes Hana (IL); Jacob Dagan, Tel Aviv (IL)

(21) Appl. No.: 14/661,640

(22) Filed: Mar. 18, 2015

Related U.S. Application Data
(60) Provisional application No. 61/954,736, filed on Mar. 18, 2014.

(51) Int. Cl. A61C 15/04; A61C 19/06

(52) U.S. Cl. CPC A61C 15/046; A61C 19/063

(57) ABSTRACT

A dental flossing device is made of an elastic material. Its central structure is a flexible, elastic, bridge strip with a cross section having different shapes. When stretched, the strip has a changeable diameter to help remove debris between teeth. The strip includes corrugations or spirals along its length and may include different drugs or flavors to give the user a medicine or a taste while cleaning the teeth. At each end of the strip, there is an elastic opposing handle. Each device is stored in a carrying case for easy removal before use. A method for making the dental flossing device out of the elastic material includes molding the elastic, flexible, bridge strip and integrally molding the elastic opposing handles at opposite ends of the strip.

### CROSS-REFERENCE TO RELATED APPLICATION

This application claims priority of U.S. Provisional Application No. 61/954,736 entitled “DENTAL FLOSSING DEVICE,” filed Mar. 18, 2014, the contents of which are incorporated herein by reference in their entirety.

### BACKGROUND OF THE INVENTION

1. Field of the Invention

The present invention relates to dental hygiene devices. Specifically, the field of the invention relates to dental floss that is held by a user to clean spaces between the user's teeth. Proper use assures removal of debris from between the user's teeth.

2. Discussion of Background Information

Dental flossing is recommended by dental professionals as a necessary daily treatment for maintaining optimal dental hygiene. If done properly, flossing can prevent the onset of gum diseases, such as gingivitis, and cavities in flossed areas.

A dental floss is typically structured from a soft thread of fibers which is inserted into inter-proximal spaces (IPSs) of the user's teeth to allow scraping of the fiber across the surface of the tooth. The scraping motion loosens debris from the dental surface, usually removing the debris from the flossed section and leaving the surface in a cleaner state, thus resulting in better oral hygiene.

However, acceptance of flossing by the general public has been limited, even after decades of warnings and educational campaigns from dental associations. People find proper flossing tedious, uncomfortable, and difficult. Many people have sensitivity and bleeding gums. Thus, flossing is not a generally accepted method of oral hygiene. For example, the younger population and people with sensitive gingiva are not using this modality. To reach and adequately floss all necessary places with current flossing devices and materials requires time, manual dexterity, and discipline, with typical discomfort, pain and occasional bleeding. Theses results cause too many people to refrain from using this important modality.

Many attempts have been made in this field to make flossing more acceptable by providing different structures and electromechanical devices. Nevertheless, flossing is not utilized by the majority of the people as a daily routine.

One known flossing device is disclosed in South Korean Published Patent Application No. KR2011-0132255 dated Dec. 7, 2011. While this disclosure addresses some of the drawbacks of the prior art, it does not address them in the same manner as the present invention which is described in greater detail below.

Therefore, it remains a problem in the dental arts to find a solution that will make flossing a more comfortable and pleasant experience, thus making flossing a more accepted solution to be used by most of the population.

### SUMMARY OF THE INVENTION

The present invention is a solution that will make flossing a more comfortable and pleasant experience. As a result of the use of the present invention, it is expected that flossing will become a more accepted dental cleaning solution which will be used by most of the population.

The tooth cleaning apparatus of the present invention includes a plurality of lengths and shapes for opposing, elastic side handles to be gripped by the user's fingers while flossing the teeth. The structure of the present invention includes a stretchable, elastic, flossing strip. Different sizes will fit youngsters or adult users, depending upon the size of each person's mouth. A central part of the invention is made from a strong elastic material which cannot be torn while being inserted into the inter-proximal spaces (IPSs) of the teeth. Also, the elastic material is bio-compatible.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of nonlimiting examples of embodiments of the present invention, in which like reference numerals represent similar parts throughout the several views of the drawings, and wherein:

FIG. 1 shows a side view of a first embodiment of the invention;

FIG. 2A shows a left side view of a second embodiment of the invention;

FIG. 2B shows a cross-sectional view along line A-A in FIG. 2A;

FIG. 2C shows a left side view of a third embodiment of the invention;

FIG. 2D shows a cross-sectional view along line B-B in FIG. 2C;

FIG. 3A shows a right side view of a fourth embodiment of the invention;

FIG. 3B shows a right side view of a fifth embodiment of the invention;

FIG. 4 shows a top plan view of a carrying case for the first embodiment of FIG. 1;

FIG. 5 shows a perspective view of a person using the first embodiment of FIG. 1;

FIG. 6A shows a side view of a sixth embodiment of the invention;

FIG. 6B shows a side view of a seventh embodiment of the invention;

FIG. 7 shows a side view of an eighth embodiment of the invention; and

FIG. 8 shows a side view of a ninth embodiment of the invention.

### DETAILED DESCRIPTION OF THE PREFERRED EMBODIMENTS

The particulars shown herein are by way of example and for the purpose of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

A dental flossing device includes a flexible, elastic, bridge strip that can be stretched by a user to be inserted into inter-proximal spaces (IPSs) of the user's teeth. The strip has a right terminal end and a left terminal end. An elastic, right gripping handle is integrally molded with the right terminal end of the strip; and an elastic, left gripping handle is integrally molded with the left terminal end of the strip. The strip and the gripping handles form a single piece out of the same elastic material. The strip has one thickness and each of the gripping handles has a thickness greater than the thickness of the strip. The thickness of each of the gripping handles is the same. Each of the gripping handles may be a hollow ring. Alternatively, each of the gripping handles may be a ring with an elastic web in its center, wherein a thickness of the elastic web is less than the thickness of each of the gripping handles. Further, each of the gripping handles may be a hollow quadrilateral. Alternatively, each of the gripping handles may be a quadrilateral with an elastic web in its center, wherein the thickness of the elastic web is less than the thickness of each of the gripping handles. In one embodiment, the right terminal end of the strip may be molded at a 270-degree point of the right gripping handle while simultaneously the left terminal end of the strip may be molded at a 90-degree point of the left gripping handle. In another embodiment, the right terminal end of the strip may be molded at a zero-degree point of the right gripping handle. The flexible, elastic, bridge strip may have at least one of, corrugations or spirals, so as to help remove debris between the user's teeth. The corrugations or spirals on the strip may be chewable and dispense either an artificial flavor or a medicine. In a further embodiment, each of the gripping handles may have rays emanating therefrom. The emanating rays may be chewable and dispense either an artificial flavor or a medicine. The dental flossing device may be stored in a carrying case made of plastic, metal, wood or a similar material. The carrying case has two posts configured to retain the gripping handles therein.

A method of making the dental flossing device includes molding a flexible, elastic, bridge strip that can be stretched by a user to be inserted into inter-proximal spaces (IPSs) of the user's teeth, said strip having a right terminal end and a left terminal end; integrally molding an elastic right gripping handle with the right terminal end of the strip; and integrally molding an elastic left gripping handle with the left terminal end of the strip; wherein the strip and the gripping handles are formed into a single piece out of the same elastic material; wherein the strip is molded to have one thickness and each of the gripping handles is molded to have a thickness greater than the thickness of the strip; and wherein the thickness of each of the gripping handles is formed to be the same.

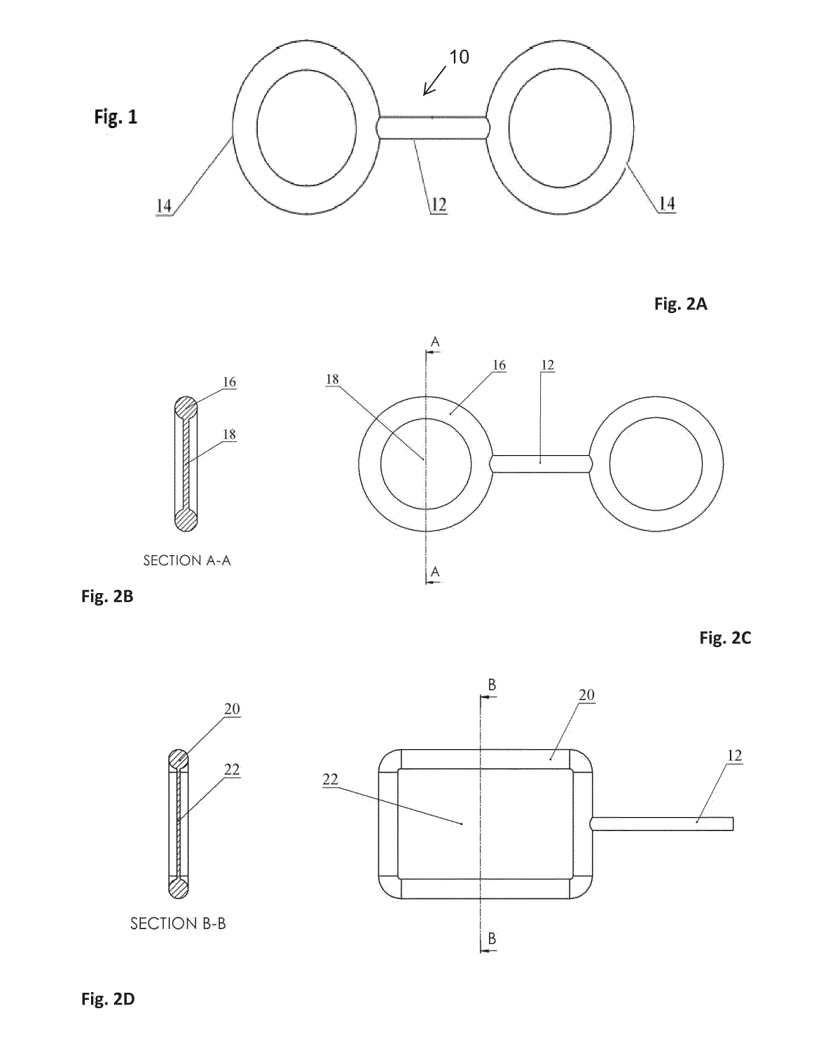

In FIG. 1, a first embodiment of a dental flossing device 10 is shown to be made of an elastic material selected from one of latex, silicone rubber, natural rubber, other synthetic rubbers, thermoplastic polymers, polystyrene, and acetyl polymers such as Delrin® and nylon resins. A central structure of the device 10 is a flexible, elastic, bridge strip 12, with a cross section having different shapes, e.g. round, square, having corrugations, and/or having spirals. The strip 12 can be one strip or two strips or a network of multiple strips. When stretched, the strip 12 has a changeable diameter to help remove debris between a user's teeth. At each terminal end of the strip 12, there is an elastic opposing gripping handle 14 in a shape like a hollow ring to fit around a user's index finger. The strip 12 has one thickness while each of the opposing handles 14 has a thickness greater than the thickness of the strip 12. The thickness of each of the opposing handles 14 is the same. The strip 12 and the opposing handles 14 are integrally molded in a single piece out of the same elastic material.

A right terminal end of the strip 12 is formed at the 270-degree point of the right handle 14. A left terminal end of the strip 12 is formed at the 90-degree point of the left handle 14. The elastic material allows the user to stretch the strip 12 so that it fits into any space between the user's teeth. More stretching will allow the strip 12 to become thinner, thus fitting into narrower spaces between the teeth.

In FIG. 2A, a left side of a second embodiment is shown in which the strip 12 has a ring-like handle 16 with a thin elastic web 18 in its center. In this second embodiment, each web 18 is gripped by the user between his index finger and his thumb.

FIG. 2B is a cross section taken along line A-A of FIG. 2A and shows the thinness of the web 18 relative to the ring-like handle 16.

In FIG. 2C, a left side of a third embodiment is shown in which the strip 12 has a quadrilateral-shaped handle 20 with a thin elastic web 22 in its center. In this third embodiment, each web 22 is gripped by the user between his index finger and his thumb.

FIG. 2D is a cross section taken along line B-B of FIG. 2C and shows the thinness of the web 22 relative to the quadrilateral-shaped handle 20.

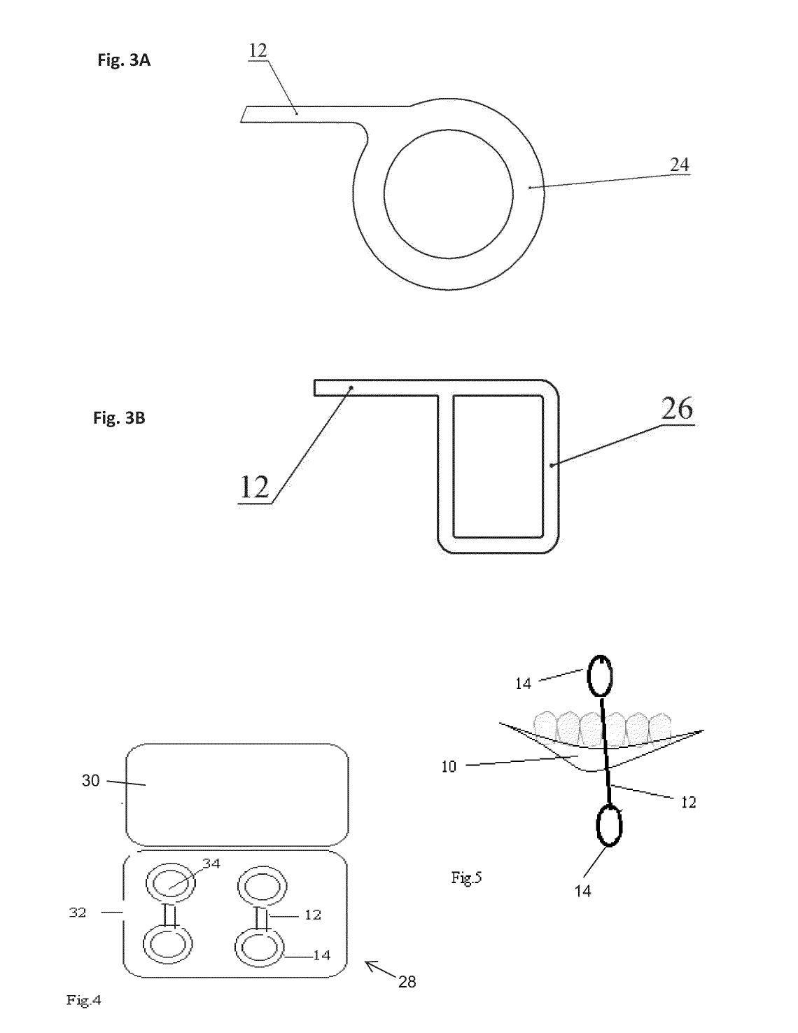

In FIG. 3A, a fourth embodiment is shown in which the strip 12 is formed at the zero-degree point of a right, hollow, ring-like handle 24 which fits around the user's index finger.

In FIG. 3B, a fifth embodiment is shown in which the strip 12 is formed at an upper left corner of a right, hollow, quadrilateral-shaped handle 26 which fits around the user's index finger.

In FIG. 4, a carrying case 28 is made of any suitable material such as metal, plastic, wood, etc., in a size to fit easily into a man's pocket or a woman's hand bag. The case 28 has a top lid 30 and a bottom tray 32 with two posts 34 for receiving the handles 14 of the first embodiment of the dental flossing device 10. The elastic strip 12 extends between the two elastic handles 14. Although two sets of the posts 34 are shown for retaining two devices 10, the case 28 may be configured to handle only one device 10 or three or more devices 10.

FIG. 5 shows use of the first embodiment of the dental flossing device 10 by the user who has placed one index finger into one of the ring-like handles 14 and who has also placed the other index finger into the other ring-like handle 14. By pulling his fingers in the opposing elastic handles 14 apart, the user stretches the central elastic strip 12 so that he is able to reach into narrow crevices between his teeth in order to remove debris therefrom.

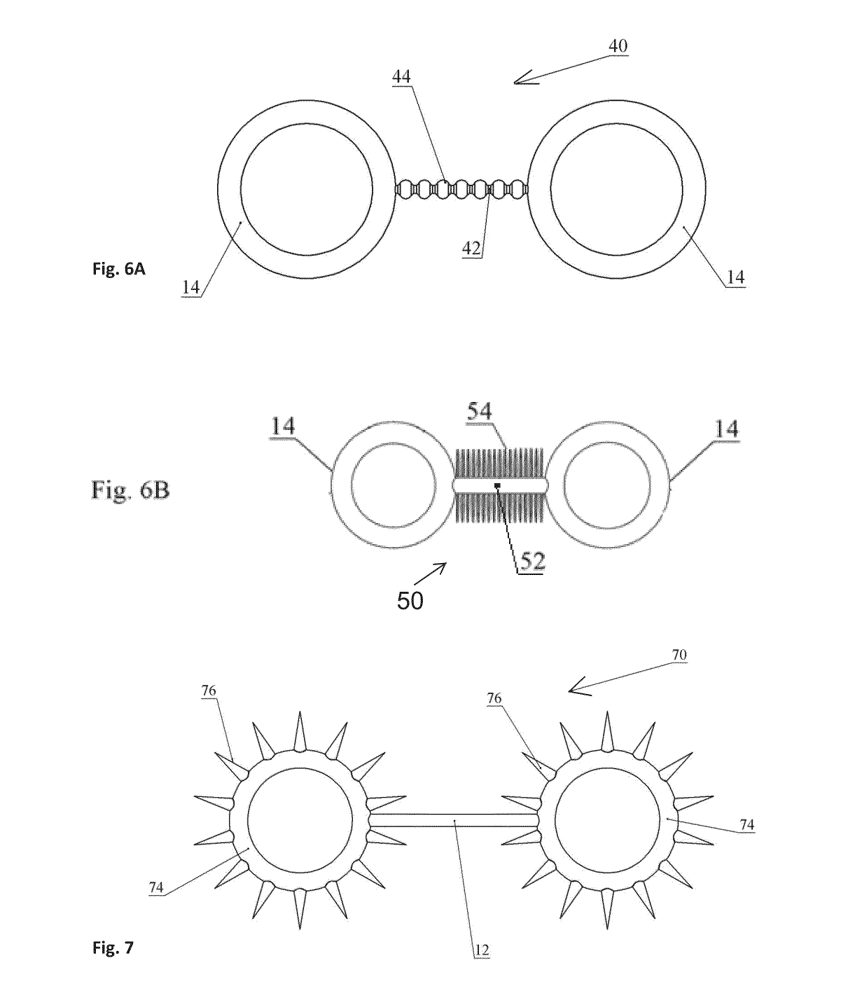

FIG. 6A shows a sixth embodiment in which a dental flossing device 40 is formed in one piece with the opposing ring-like handles 14 having an elastic, central strip 42 with corrugations 44 therebetween.

Corrugations 44 along the elastic strip 42 assist the user in removing debris from spaces between his teeth. These corrugations 44 are chewable and may dispense either an artificial flavor or a medicine.

FIG. 6B shows a seventh embodiment in which a one-piece, dental flossing device 50 with the opposing ring-like handles 14 has a central, elastic, strip 52 therebetween. Spirals 54 along the strip 52 assist the user in removing debris from spaces between the user's teeth. These spirals 54 may also be chewable and dispense either an artificial flavor or a medicine.

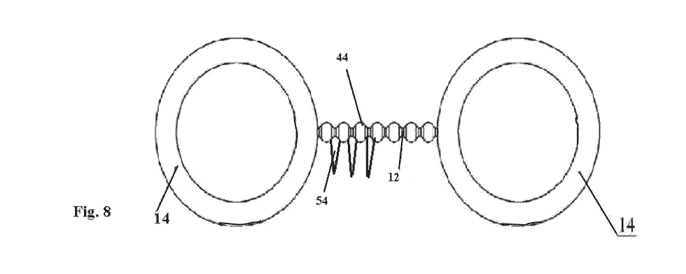

FIG. 7 shows an eighth embodiment in which a one-piece dental flossing device 70 with opposing, elastic, ring-like handles 74 has the central strip 12 therebetween. The handles 74 have emanating rays 76 which likewise may be chewable and dispense either an artificial flavor or a medicine.

In one or more embodiments, the spirals 54 and corrugations 44 can be on the same strip 12, as shown in FIG. 8.

The strip 12, the strip 42 with its chewable corrugations 44, and the strip 52 with its chewable spirals 54 may also include different drugs or flavors to give the user a medicine or a taste while cleaning the teeth. Flavors like mint, banana, peach, etc. and matching colors of the strip 12, the strip 42, the corrugations 44, the strip 52 and the spirals 54 will give the user different tastes while cleaning the teeth. The strip 12, the strip 42, the corrugations 44, the strip 52 and the spirals 54 may further include different drugs which, by their fast release at narrow crevices between the teeth, even for a short period of time, will induce different healing effects. The strip 12, the strip 42, the corrugations 44, the strip 52, the spirals 54, and the rays 76, with either medicines or flavors or both impregnated therein, entice reluctant users, particularly children, to floss whenever needed, thus enhancing their dental hygiene.

It is noted that the foregoing examples have been provided merely for the purpose of explanation and are in no way to be construed as limiting the present invention. While the present invention has been described with reference to some exemplary embodiments, it is understood that the words which have been used herein are words of description and illustration, rather than words of limitation. Changes may be made, within the purview of the appended claims, as presently stated and as amended, without departing from the scope and spirit of the present invention in all of its various aspects. Although the present invention has been described herein with reference to particular structures, materials and embodiments, the present invention is not intended to be limited to the particulars disclosed herein. Rather, the present invention extends to all functionally equivalent structures, methods and uses, such as are within the scope of the appended claims.

What we claim as our invention is:

1. A dental flossing device comprising:
a flexible, elastic, bridge strip that is stretchable by a user to be inserted into inter-proximal spaces (IPSs) of the user's teeth, said strip having a right terminal end and a left terminal end;
an elastic, right gripping handle integrally molded with the right terminal end of the strip; and
an elastic, left gripping handle integrally molded with the left terminal end of the strip;
wherein the strip and the gripping handles form a single piece out of a same elastic material;
wherein the strip has one thickness and each of the gripping handles has a thickness greater than the thickness of the strip;
wherein the thickness of each of the gripping handles is the same; and
wherein the strip has at least one of, corrugations, or spirals along its length.

2. The dental flossing device according to claim 1, wherein each of the gripping handles is a hollow ring.

3. The dental flossing device according to claim 1, wherein each of the gripping handles is a ring with an elastic web in its center and further wherein a thickness of the elastic web is less than the thickness of each of the gripping handles.

4. The dental flossing device according to claim 1, wherein each of the gripping handles is a hollow quadrilateral.

5. The dental flossing device according to claim 1, wherein each of the gripping handles is a quadrilateral with an elastic web in its center and further wherein a thickness of the elastic web is less than the thickness of each of the gripping handles.

6. The dental flossing device according to claim 1, wherein:
said right terminal end of the strip is molded at a 270-degree point of the right gripping handle; and
said left terminal end of the strip is molded at a 90-degree point of the left gripping handle.

7. The dental flossing device according to claim 1, wherein:
said right terminal end of the strip is molded at a zero-degree point of the right gripping handle.

8. The dental flossing device according to claim 1, wherein the flexible bridge strip has corrugations and spirals along it so as to help remove debris between the user's teeth.

9. The dental flossing device according to claim 1, wherein the flexible bridge strip is spiraled so as to help remove debris between the user's teeth.

10. The dental flossing device according to claim 1, wherein each of the gripping handles has rays emanating therefrom.

11. The dental flossing device according to claim 8, wherein the strip has corrugations which are chewable and dispenses at least one of, an artificial flavor or a medicine.

12. The dental flossing device according to claim 9, wherein the spiraled strip is chewable and dispenses at least one of, an artificial flavor or a medicine.

13. The dental flossing device according to claim 10, wherein the emanating rays are chewable and dispense at least one of, an artificial flavor or a medicine.

14. The dental flossing device according to claim 1, wherein the device is stored in a carrying case made of one of plastic, metal, wood and similar material.

15. The dental flossing device according to claim 14, wherein the carrying case has two posts configured to retain the gripping handles therein.

16. A dental flossing device comprising:
a flexible, elastic, bridge strip that is stretchable by a user to be inserted into inter-proximal spaces (IPSs) of the user's teeth, said strip having a right terminal end and a left terminal end;
an elastic, right gripping handle integrally molded with the right terminal end of the strip; and
an elastic, left gripping handle integrally molded with the left terminal end of the strip;
wherein the strip and the gripping handles form a single piece out of a same elastic material;
wherein the strip has one thickness and each of the gripping handles has a thickness greater than the thickness of the strip;
wherein the thickness of each of the gripping handles is the same;
wherein each of the gripping handles is a hollow ring;
wherein the right terminal end of the strip is molded at a zero-degree point of the right gripping handle;
wherein the device is stored in a carrying case made of one of plastic, metal, wood and similar material;
wherein the carrying case has two posts configured to retain the gripping handles therein; and
wherein the strip has at least one of, corrugations, or spirals along its length.

17. A method of making a dental flossing device, comprising:
molding a flexible, elastic, bridge strip that is stretchable by a user to be inserted into inter-proximal spaces (IPSs) of the user's teeth, said strip having a right terminal end and a left terminal end;
integrally molding an elastic, right gripping handle with the right terminal end of the strip;
integrally molding an elastic, left gripping handle with the left terminal end of the strip;
forming the strip and the gripping handles into a single piece out of a same elastic material;
molding the strip to have one thickness and molding each of the gripping handles to have a thickness greater than the thickness of the strip; and
forming the thickness of each of the gripping handles so as to be the same,
wherein the strip has at least one of, corrugations, or spirals along its length.

18. The method according to claim 17, further comprising:
molding each of the gripping handles as a hollow ring.

19. The method according to claim 17, further comprising:
molding each of the gripping handles as a ring with an elastic web in its center and forming a thickness of the elastic web to be less than the thickness of each of the gripping handles.

20. The method according to claim 17, further comprising:
molding each of the gripping handles to be a hollow quadrilateral.
